(19) United States
(12) Patent Application Publication
(10) Pub. No.: US 2009/0196627 A1
(43) Pub. Date: Aug. 6, 2009

(54) DISTRIBUTED DRIVER AND CAN BUS COMMUNICATION PROTOCOL

(75) Inventors: Torben Kaas Rasmussen, Aarhus (DK); Thomas Vinter, Beder (DK); Henrik Douglas Green, Hoejbjerg (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: MARTIN PROFESSIONAL A/S, Aarhus (DK)

(21) Appl. No.: 12/107,821

(22) Filed: Apr. 23, 2008

(30) Foreign Application Priority Data
Feb. 5, 2008 (DK) PA 2008 00152

(51) Int. Cl. H04B 10/12

(52) U.S. Cl. 398/182

(57) ABSTRACT

A system and a method for internal communication in a lighting system, which lighting system comprises a computer for controlling the lighting system, in which system a number of motors or actuators are controlled by the computer system, which motors or actuators control the operation of light effect components in relation to the lighting system, where the computer further controls a number of functions in the lighting system, which computer is controlled by input means. The computer system can be centrally placed where control information generated in the computer system is distributed to a number of distributed drivers over a data bus, where distributed drivers are in operation physically close to the motors or actuators, where distributed drivers based on data received from the data bus, perform control of actuators or motors.

### BACKGROUND OF THE INVENTION

1. Field of the Invention

The pending patent application relates to a lighting system comprising at least one light source, which light source generates a beam of light, which beam of light is passing through a lens system, which beam of light is passing through at least one colour forming system, which colour forming system comprises a first set of motors, which motors are connected to a first set of drivers, which beam of light is passing through a light effect system, which light effect system comprises a second set of motors, which motors are connected to a second set of drivers, which first and second set of drivers are connected to a computer system, which computer system is communicating through a communication bus connected to at least the first and second set of drivers,

The pending patent application further relates to a method for internal communication in a lighting system, which lighting system comprises a computer for controlling the lighting system, in which system a number of motors or actuators are controlled by the computer system, which motors or actuators control the operation of light effect components in relation to the lighting system, where the computer further controls a number of functions in the lighting system, which computer is controlled by input means.

2. Description of Related Art

U.S. Pat. No. 5,448,180 concerns a transmitter end stage for a data transmission system comprising at least one control unit and data transmission lines, especially for a CAN bus system having at least one CAN controller and one CAN bus, characterized by the fact that the individual circuit elements of transmitter end stage are integrated monolithically. As a result of the special layout and its circuit-design arrangement of the individual elements of the transmitter end stage, the effects of malfunctions, for example of short circuits of the data lines to ground or to the supply voltages, are reduced to a minimum. As a result of the special choice of pre-drivers, minimum delay times are achieved, so that signals can be transmitted at a higher data rate.

U.S. Pat. No. 5,448,561 concerns an improved method for exchange of data in data processing installations, especially Controller Areas Networks (CAN), which permits acknowledged and segmented transmission of data strings, of arbitrarily long length, between at least two stations in the network or other data processing installation. The method includes the transmission of the messages associated with the data by means of frames; the frames contain a header field and a data field. In the event of contention between multiple stations of the data processing installation for access to the bus connection, which frame has priority is determined by evaluating the respective header fields. In the data field of the frame, there is a control information field containing a message code which serves to identify the message type. The message codes distinguish among activation messages, data messages, and acknowledgement messages. This permits transmission of data strings, of limited length, with acknowledgement. Further, the control information fields of certain messages contain a sequence number, a receiver status code, a message end code, and a code specifying how many data bytes are being transmitted in the frame. With this additional information, data strings of arbitrarily long length may be transmitted as segments. The receipt of the individual partial messages is confirmed by sending back an acknowledgment in each case.

U.S. Pat. No. 5,539,778 concerns a receiving comparator for a data-transmission system comprising at least one control unit and data-transmission lines, in particular for at least one Controller Area Network (CAN) controller and one CAN bus system having a CAN bus (CB), which is distinguished by the feature that the individual circuit elements are monolithically integrated. By generating a switching threshold which is independent of the operating voltage and temperature with the aid of a current source (IS), one prevents the CAN bus potentials from being asymmetrically influenced. The arrangement guarantees a processing of digital signals with a high data rate, whereby the input common-mode range extends up to above the supply voltage and to below ground.

U.S. Pat. No. 5,572,658 concerns a network interface which is designed for two-wire reception via a serial bus and has a differential receiver which is connected to input lines. The network interface likewise has an element for recognizing error states on the bus lines. It is designed such that it changes into single-wire operation after recognizing the error state, in order to maintain the data traffic. In this case, one input line is connected to a fixed terminal potential. The terminal potential is in this case selected such that the magnitude of the potential difference between the two input lines is the same for both bit levels.

EP 0 382 794 B1 concerns a network interface, in particular for motor vehicles having at least two processors and at least two buses, which comprises a monitoring circuit which monitors the performance of the buses and an emergency circuit controlled by the monitoring circuit. The comparator of a receiving or signal evaluation circuit can be used even with a single functional bus in the event of a short circuit in one of the buses connected to a terminal unit after the supply voltage UB or earth or in the event of a defect in the driver stage of a component of the network connected to the bus. The network interface is therefore characterized by outstanding reliability.

### SUMMARY OF THE INVENTION

It is the object of the invention to reduce the number of cables in a lighting system.

This object can be achieved by a lighting system as described in the preamble to claim 1 if the first and second set of drivers are placed physically close to the set of motors related to that specific set of drivers, where a specific driver is allocated to each motor and where a computer system is placed centrally in a distance to the set of drivers, where communication from the computer system to the set of drivers is performed at a data bus by a specific communicating protocol.

Hereby, communication is performed in a highly efficient way over the data bus. Only wiring for the data bus needs to be used for the communication. In lighting units, where a moving head has to be moved in relation to a yoke which yoke is moved in relation to a base, it is important that the number of wires can be reduced as much as possible. Placing the drivers in relation to the motors or even physically placing the drivers inside the motors provides the possibility that the drivers always know the actual position of the motor. When new position data are received over the data bus, the driver can calculate the difference and start moving the motor into the next position. In some situations, the new positions are sent to the drivers in order to prepare a movement but wait for a synchronisation signal. This is also a possibility using data bus communication in e.g. a moving head light fixtures. The computer system can also be relatively simple in operation as the direct motor control is performed by the drivers, and the computer system only has to calculate the next position for the motors. Most of the data transactions performed in e.g. a moving headlight fixture are then performed in the distributed drivers. In some situations, data communication can also be transmitted from the drivers to towards the computer system. By using an internal communication bus, it is of course possible to use two way communications.

Preferably, receiving drivers are programmed to react at data segments carried in time slots in the communication protocol. Hereby, it is achieved that all data is available all the time at the data bus for all connected drivers. The programming of the individual driver defines which information that driver uses in the data bus.

The computer system can at least comprise program modules for the following purposes of calculating the actual motor position in the colour forming system based on colour input data, calculating the actual motor position in the light effect system based on light effect input data, calculating the actual motor position in a zoom module based on zoom input data, calculating the actual motor position in the pan or tilt motors based on pan or tilt input data, calculating and controlling the cooling activity, where the computer system can continuously transmit calculated data to at least actual motor drivers, based on measured or predicted temperature in the lighting system. In a situation during operation where the computer system is receiving data from the outside, the computer system has a number of activities which are to be calculated, and data has to be transmitted further over the internal data bus. Not only control data which contains information about new motor position is transmitted to different modules but also e.g. temperature data based on measured temperatures or maybe even predicted temperatures is received in the computer system, the computer system can use the data bus for communication to cooling systems which comprise motors where the speed has to be regulated.

Preferably, the communication protocol used is a Controller Area Network (CAN) bus protocol. The CAN bus is a very reliable communication protocol even when used in a harsh environment. Thus, both electric sparks and high frequency electromagnetic radiation have only very limited influence on the CAN bus. Therefore, the CAN bus provides reliable communication internal in a lighting system.

Furthermore, a zoom module can comprise a third driver, which driver is communicating with the computer system by the CAN bus protocol. Hereby, it can be achieved that also communication to the zoom module is performed by the CAN bus protocol.

Pan and tilt motors can also be connected to a driver, which driver is communicating with the computer system by the CAN bus protocol. Also motors for pan and tilt can be controlled by drivers connected to the CAN bus.

In an alternative embodiment of the invention, the communication protocol can be a SPI Bus. The Serial Peripheral Interface bus or SPI is a synchronous serial data communication standard which operates in full duplex mode. Devices communicate in a master communication mode where the master device initiates the data frame. Multiple communication devices are allowed with individual communication selected lines.

Therefore, the SPI bus could be an alternative to the CAN bus.

The communication protocol can also be an I2C Bus. The I2C bus is a simple by-directional-two-wire. The I2C bus is used for communication functions between intelligent control devices, e.g. micro-controllers. Therefore, the I2C bus is also a possible alternative to the CAN bus.

In a further embodiment of the invention, the communication protocol can be a CANopen protocol. In a CANopen network, there must be at least one master application and one or several slave applications. The master application performs the booth up process and checks and maintains the network in operational state. It also manipulates the object dictionary entries and the CAN identifiers of the collected devices. The communication profile defines several methods for transmission and reception of messages over the CAN bus.

Therefore, the CANopen databus is probably the best alternative to the normal CAN bus.

Preferably, the computer system comprises at least one input/output for a DMX signal. For a light fixture, it is a must that the light fixture can be connected to a DMX signal. For correct operation, there must be both DMX input and DMX output. Only by linking a number of light fixtures to the same DMX signal, they can operate from the same light controller.

Alternatively, the computer system can comprise at least one input/output for a RDM based on EIA-485 Bus interface. As an alternative to the DMX signal, the light fixtures can communicate with a light control system over a RMD network.

Instead, the computer system can comprise at least one input/output for an EIA-422 Bus interface. This can be a highly efficient communication network when the cable length is less than 500 metres.

The computer system can also comprise at least one input/output for a USB connection. The use of e.g. USB 2.0 can give relatively high data speed communication towards the computer system.

The computer system also comprises at least one input/output for an Ethernet connection. By letting Ethernet connection be a possibility, there can be a connection between the lighting system and a normal Ethernet communication system.

The object of the invention can be achieved by a method as described in the preamble to claim 15 if the computer is centrally placed and control information generated in the computer is distributed to a number of distributed drivers over a data bus, where the distributed drivers are in operation physically close to motors or actuators and where the distributed drivers based on data received from the data bus perform control of actuators or motors.

By this method for communication inside a lighting system, most of the control can be performed in drivers placed closely to or maybe inside motors or actuators. As the drivers have access, maybe directly, to the position indication in motors or actuators, the drivers need to calculate the difference between the actual position and a new position received over the data bus. Thereby, calculation of motor position is performed directly in the driver as close to the motor as possible. This reduces data communication inside the lighting unit. By using a data bus for two-way communication, all detectors which could be actual position in motors in the lighting system can be transmitted towards the computer system. By a request from the outside towards the computer system, all data received from position detectors or maybe temperature detectors placed in the lighting system can be transmitted over external communication lines.

The computer system can transmits data to all drivers, which protocol defines a number of data segments transmitted in time slots in the protocol, where receiving drivers can be programmed to react at data segments carried in the time slots.

Hereby, it is achieved that the data bus can contain all information all the time. But the individual driver is only listening to the part of the communication directly directed to that specific driver.

The method further operates the computer system to perform calculations by program modules for the following purposes of, calculating the actual motor position in the colour forming system based on colour input data, calculating the actual motor position in the light effect system based on light effect input data, calculating the actual motor position in a zoom module based on zoom input data, calculating the actual motor position in the pan or tilt motors based on pan or tilt input data, and calculating and controlling the cooling activity based on measured or predicted temperature in the lighting system, where the computer system continuously transmits calculated data to at least actual drivers. Hereby, it is achieved that the different mechanical and electrical modules in the lighting system are operated by controlling the drivers over the data bus. The temperature data is handled over this data bus.

Preferably, communication to or from the computer system is performed by a Controller Area Network (CAN) bus protocol. The CAN bus is one of the most reliable bus protocols ever performed and is e.g. also widely used in cars. Therefore, the CAN bus will also be highly efficient in the relatively harsh environment of a lighting system. Thus, sparks and other kinds of electromagnetic noise have very limited influence on the CAN bus.

### BRIEF DESCRIPTION OF THE DRAWING

The sole FIGURE is a schematic diagram of the internal modules in one possible embodiment of a lighting system.

### DETAILED DESCRIPTION OF THE INVENTION

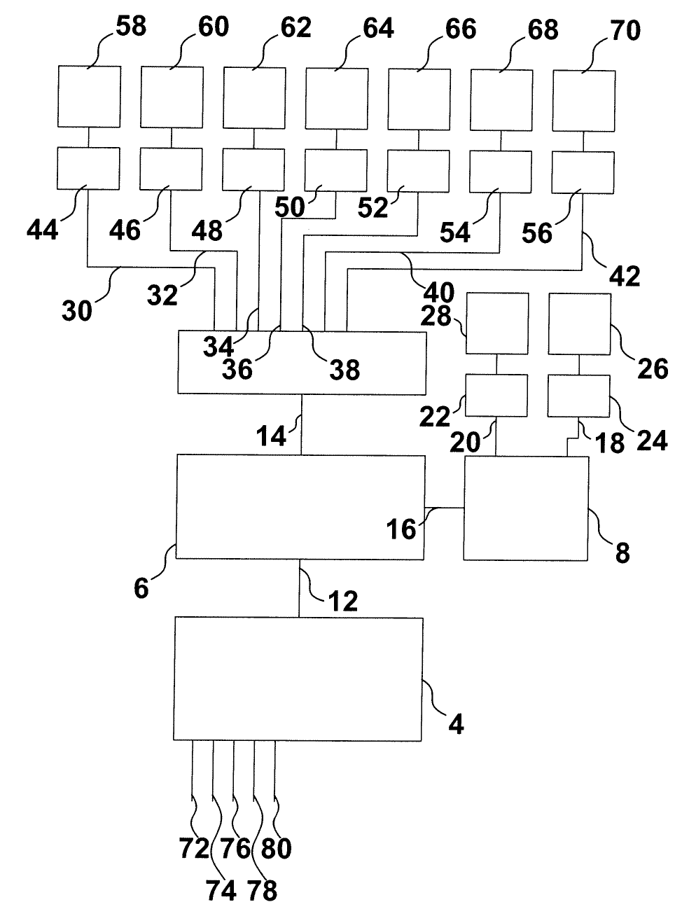

FIG. 1 shows a schematic diagram of the internal modules in one possible embodiment of a lighting system 2. The lighting system 2 comprises a computer module 4 which could be placed in a base in a lighting system. The lighting system 2 further comprises a yoke distribution module 6 where a data bus 12 is communicating from the computer system 4 to the yoke module 6. From the yoke distribution module 6, there is further a communication line 14 towards a distribution head module 10. From the distributed yoke module 6, there is also a data bus connection 16 towards pan and tilt module 8. From this pan and tilt module 8, the data bus connections 18 and 20 go into drivers 22 and 24. The driver 22 is connected to a motor 28, and the driver 24 is connected to a motor 26. The distributed head module 10 comprises the data bus connections 30, 32, 34, 36, 38, 40 and 42 towards the drivers 44, 46, 48, 50, 52, 54, 56. All these drivers are further connected to motors 58, 60, 62, 64, 66, 68 and 70. Furthermore, the computer system 4 comprises at least the following input lines 72, 74, 76, 78, 80. 72 indicates input and output for DMX signals. 74 indicate input/output for IDM based on IEA485 bus interface. 76 is an indication of a terminal for IEA422 bus interface. The terminal 78 is a USB connection, and 80 is a terminal for Ethernet connection.

In operation, the computer system 4 will over the data bus 12 and through the distributed yoke module 6 transmit data over data bus 14 towards the distributed head module 10 from where the signal is transmitted over the data buses 30, 32, 34, 36, 38, 40, 42 towards the related drivers 44, 46, 48, 50, 52, 54, 56. Here calculations are performed and motors 58, 60, 62, 64, 66, 68, 70 are under control. Input signals received by the computer system 4 are calculated in this computer system and subsequently transmitted to related drivers. The drivers know the actual position of the motors, and they perform calculation the actual difference in position. The pan and tilt drivers 22, 24 are also controlled by the module 8, and the data bus 16. Not shown on this FIGURE is the presence of a number of detectors in the lighting system. These detectors, which could be temperature sensors, also communicate over the data bus so that measured signals can be transmitted over the data bus towards the computer system 4. The computer system 4 can perform temperature regulation by controlling, e.g., blowing units placed near the light source. If the computer system 4 gets information about the different motor positions around the lighting system, the heat distribution in the lighting system can be calculated. Based on calculated heating, the cooling system can be activated before any increase in temperature starts up in a moving head projecting lamp.

What is claimed is:

1. A lighting system comprising at least one light source, which light source generates a beam of light, which beam of light is passing through a lens system, which beam of light is passing through at least one colour forming system, which colour forming system comprises a first set of motors, which motors are connected to a first set of drivers, which beam of light is passing through a light effect system, which light effect system comprises a second set of motors, which motors are connected to a second set of drivers, which first and second set of drivers are connected to a computer system, which computer system is communicating through a communication bus connected to at least the first and second set of drivers, wherein the first and second set of drivers are placed physically close to the set of motors related to that specific set of drivers, wherein a specific driver is allocated to each motor, which computer system is placed centrally in a distance to the set of drivers, and wherein communication primarily from the computer system to the set of drivers is performed at a data bus by a specific communication protocol.

2. A lighting system according to claim 1, wherein receiving drivers are programmed to react at data segments carried in time slots in the communication protocol.

3. A lighting system according to claim 1, wherein the computer system at least comprises program modules for the following purposes:
calculation of the actual motor position in the colour forming system based on colour input data,
calculation of the actual motor position in the light effect system based on light effect input data,
calculation of the actual motor position in a zoom module based on zoom input data,
calculation of the actual motor) position in the pan or tilt motors based on pan or tilt input data,
calculation and control of the cooling activity based on measured or predicted temperature in the light system,
wherein the computer system continuously transmits calculated data to at least the actual motor drivers.

4. A lighting system according to claim 3, wherein communication over the data bus is performed by a Controller Area Network (CAN) bus protocol.

5. A lighting system according to claim 4, wherein a zoom module comprises a third driver, which driver is communicating towards the computer system by the CAN bus protocol.

6. A lighting system according to claim 4, wherein pan and tilt motors are connected to a fourth set of drivers, which drivers are communicating towards the computer system (4) by the CAN bus protocol.

7. A lighting system according to claim 3, wherein the communication protocol is a SPI Bus.

8. A lighting system according to claim 3, wherein the communication protocol is an I2C Bus.

9. A lighting system according to claim 3, wherein the communication protocol is a CAN open protocol.

10. A lighting system according to claim 4, wherein the computer system comprises at least one input/output for a DMX signal.

11. A lighting system according to claims 4, wherein the computer system comprises at least one input/output for a RDM based on EIA-485 Bus interface.

12. A lighting system according to claim 4, wherein the computer system comprises at least one input/output for an EIA-422 Bus interface.

13. A lighting system according to claim 4, wherein the computer system comprises at least one input/output for a USB connection.

14. A lighting system according to claim 4, wherein the computer system comprises at least one input/output for an Ethernet connection.

15. A method for internal communication in a lighting system, which lighting system comprises a computer system for controlling the lighting system, in which lighting system a number of motors or actuators are controlled by the computer system, which motors or actuators control the operation of light effect components in relation to the lighting system, where the computer system further controls a number of functions in the lighting system, wherein the computer system is centrally placed where control information generated in the computer system is distributed to a number of distributed drivers over a data bus, where distributed drivers are in operation physically close to the motors or actuators, where distributed drivers based on data received from the data bus, perform control of actuators or motors.

16. Method according to claim 15, wherein the computer system transmits data to all drivers which protocol defines a number of data segments transmitted in time slots in the protocol, where receiving drivers are programmed to react at data segments carried in the time slots.

17. Method according to claims 15, wherein the computer system performs calculation by program modules for the following purposes of:
calculating the actual motor position in the colour forming system based on colour input data,
calculating the actual motor position in the light effect system based on light effect input data,
calculating the actual motor position in a zoom module based on zoom input data,
calculating the actual motor position in the pan or tilt motors based on pan or tilt input data,
calculating and controlling the cooling activity based on measured or predicted temperature in the lighting system,
wherein the computer system continuously transmits calculated data to at least actual drivers.

18. Method according to claim 17, wherein communication to or from the computer systems performed by a Controller Area Network (CAN) bus protocol.
